(19) United States
(12) Patent Application Publication
(10) Pub. No.: US 2014/0156034 A1
(43) Pub. Date: Jun. 5, 2014

(54) METHOD FOR APPLYING A CONSCIOUSNESS FIELD TO INDUSTRIAL PROCESSES

(71) Applicant: Mohammad Ali Taheri, Tehran (IR)

(72) Inventor: Mohammad Ali Taheri, Tehran (IR)

(21) Appl. No.: 13/691,596

(22) Filed: Nov. 30, 2012

(51) Int. Cl. G05B 15/00

(52) U.S. Cl. CPC G05B 15/00
USPC 700/83

(57) ABSTRACT

Provided is a method for applying a consciousness field to industrial processes.

### BACKGROUND SECTION OF THE INVENTION

It has been more than three decades that two medical therapeutic approaches; Faradarmani & Psymentology, have been known. The scientific approaches are partly based on the function of the ‘Consciousness Fields’ in connection with the ‘Interuniversal Consciousness Internet’, i.e., the Consciousness governing the Universe and rules governing them.

The ‘Consciousness Field’, however, has not been applied to industrial processes and it has not been demonstrated that the consciousness field would have any effect on an industrial process. There is a need in the art to improve an industrial process with the consciousness field.

Provided is a method for improving product of an industrial process, comprising: a) having a person who is connected to the Interuniversal Consciousness, the connection inherently existing in every person,(that exists inherently in every person) to exhibit a consciousness field; b) having the person apply the consciousness field to an industrial process by associating the industrial process with the consciousness field to produce a product with a quality that is superior to a product obtained from the same industrial process without use of a consciousness field. The person can obtain the consciousness field by communicating with another person who already is connected to the Interuniversal Consciousness. The communication can be in person. The communication can be over a network connection. The consciousness field that is applied can be one or more of general consciousness field (Faradarmani), defensive radiation (Non organic Faradarmani), Purposeful Faradarmani (shared mind), and combination thereof (all radiation). The method can result in a change of form and arrangement of molecules. The method can result in formation or analysis of new compound or molecules. The method can result in a structure rehabilitation. The applying of the consciousness field involves being present at least once during the manufacturing process. Examples of products include cement, nano materials and products, composites, alloys, catalysts, mixtures of chemicals, formulations of chemicals/ingredients, pharmaceuticals, disinfectants, and pain relievers. Information on people having interuniversal consciousness is readily available on the internet. (also see http://erfanehalgheh.com/).

### BRIEF DESCRIPTION OF THE FIGURES

FIG. 1 illustrates a blade that can spin around its middle axis.

FIG. 2 illustrates the visual illusion of blade of FIG. 1 when in motion.

FIG. 3 is an illustration of an atom nucleus.

FIG. 4 is an illustration of an atom nucleus.

FIG. 5 is an illustration of the Universe structure composed of consciousness, Matter and Energy.

FIG. 6 is an illustration of all the elements of the material universe which exist in a given time simultaneously.

FIG. 7A is an illustration of change in frequency depending on distance to a light or sound source.

FIG. 7B shows a person moving farther from a light source.

FIG. 8A is an illustration of change in frequency depending on distance to a light or sound source.

FIG. 8B shows a person moving closer to a light source.

FIG. 9 illustrates an observer's true and real visual field.

FIG. 10 illustrates the visual image based on the observer's eye frequency.

FIG. 11 illustrates the scenery of the physical world in view of speed of light.

FIG. 12 illustrates the scenery of the physical world in view of the curvature of space.

FIG. 13 illustrates the Interuniversal Consciousness Internet.

FIG. 14 illustrates average of the compressive strength values for different samples in different time periods.

FIG. 15 illustrates average of the bending strength values for different samples in different time periods.

FIG. 16 is an XRD Curve for a Control sample.

FIG. 17 is an XRD Curve for sample prepared by All Radiations.

FIG. 18 is an XRD Curve for sample prepared by Faradarmani.

FIG. 19 is an XRD Curve for sample prepared by Defensive Radiation.

FIG. 20 is an XRD Curve for sample prepared by Shared Mind.

FIG. 21 is an SEM photography of internal break up, in 2500× scale—Control.

FIG. 22 is a SEM photography of internal break up, in2500× scale—All radiation.

FIG. 23 is a SEM photography of internal break up, in 2500× scale—Faradarmani.

FIG. 24 is a SEM photography of internal break up, in 2500× scale—Defensive Radiation.

FIG. 25 is a SEM photography of internal break up, in 2500× scale—Shared Mind.

FIG. 26 is a SEM photography of internal break up, in 19× scale—Control.

FIG. 27 is a SEM photography of internal break up, in 19× scale—All radiation.

FIG. 28 is a SEM photography of internal break up, in 19× scale—Faradarmani.

FIG. 29 is a SEM photography of internal break up, in 19× scale—Defensive Radiation.

FIG. 30 is a SEM photography of internal break up, in 19× scale—Shared Mind.

FIG. 31 is a SEM photography of contact position with glass, in 5000× scale—Control.

FIG. 32 is a SEM photography of contact position with glass, in 5000× scale—All Radiation.

FIG. 33 is a SEM photography of contact position with glass, in 5000× scale—Faradarmani.

FIG. 34 is a SEM photography of contact position with glass, in 5000× scale—Defensive Radiation.

FIG. 35 is a SEM photography of contact position with glass, in 5000× scale—Shared Mind.

### DETAILED DESCRIPTION OF THE INVENTION

The consciousness field can be applied to industrial processes to produce products with superior properties. When the consciousness field was applied to cement, cement with superior properties was produced, as illustrated by the experimental data provided herein.

Through the ‘Consciousness Field’ one can have specific purposeful effects on particles, molecules and materials. In the other words, particles and materials under the Consciousness Field will show purposeful behaviors based on some rules, which can be evaluated.

It's worth mentioning that this science is based on the theory of Mono Form Universe, i.e., the Universe created out of Consciousness or Intelligence, and connection and communication to the ‘Interuniversal Internet’/ the ‘Interuniversal Consciousness’ as the great internet having all software programs and information of the Existence.

In order to study impact on behavior of particles through “Interuniversal Consciousness”, first we look at the theory of “Interuniversal Consciousness, i.e., the Intelligence or Consciousness governing the universe”. For this purpose, we raise a new topic called “the Coin of existence” by which, we can prove the Consciousness governing the material universe. We assume everything in the material universe is like a coin with two faces: one face “Reality of Existence” and the other face “Truth of Existence”. Reality of Existence includes the happening and occurrence of something. Truth of Existence includes Study of the cause of occurrence (Cause), Study of the meaning, nature of occurrence (Why). and Study of the quality of occurrence

Reality of Existence of each phenomenon indicates that it has come to existence, has taken place, has happened or has been created whether we know the cause, quality and how of its occurrence or not.

This part of existence is either observable or affects the environment, or can be recordable, storable and measurable, or may display some of these characteristics together.

For example the “being” of a piece of stone is real. It's been created regardless of our knowledge or lack of knowledge about how it has been created.

There are also phenomena which are not seen or felt but still have reality. It is also possible that something has a reality, though we may not see or feel it. For example although we do not see or touch Infra Red light, it has reality and we can measure or utilize it using of some equipments.

Truth of Existence examines different aspects of reality of existence.

For instance, why has a piece of stone been created? Or why has the universe come to existence? what factors have caused it to be?

Any reality must have happened following a plan and design. Examining the hidden aspects of each reality, one can come across the plan and design of existence of that reality and thus study it in the right way. For instance, why and for what purpose has human being come to existence? What is the meaning and nature of creation of the universe?

Quality of Occurrence examines if something has truth fundamentally, whether we are assured of its reality or not. Quality of Occurrence also examines a reality closely in relation to a criteria and study if a given reality truly exists in outside world or it is merely virtual.

For instance the image of an object in a mirror has reality of existence, it has come to existence through the mirror but it has not truth of existence since the image is virtual in respect of the object itself.

Thus, there can be things in the universe which have occurred in the Universe and so have reality while do not have truth of existence. And vice versa, there are things which might not have reality to us, while they have truth of existence. For instance, Infra Red light that cannot be seen by our eyes and thus may not have reality to us, but has truth of existence in respect of our eyes since it can be detected by some equipments.

Another example is the aura surrounding each human. As it is not visible through naked eyes, it was not considerable to be real and was supposed to be a superstition for many years. However nowadays, it becomes visible through Kirlian technology and photography. Therefore although the human aura is not visible (through naked eyes), yet it has existential truth. Thus, existential truth studies the how and quality of being of a subject or phenomenon.

Now in order to understand “The Interuniversal Consciousness”, we need to closely examine the existential truth and existential reality of the material universe itself, and subsequently talk about “the virtual world”.

Let us suppose a blade that can spin around its middle axis as shown in (FIG. 1-A). Does the blade have existential reality in the still position?

The answer is yes, because this blade has come to existence, and it's real. Now If we make the blade spin rapidly around its middle axis (as in FIG. 1), what we see is a cylinder. The diameter of the cylinder's base is the blade's width and cylinder's height is the blade's length (FIG. 2). Now a question comes out: Is this cylinder real? The answer is yes. It is real because it has occurred but is this cylinder also true? The answer is no, because such cylinder has not external existence and as soon as the blade stops moving, the cylinder disappears. Therefore this cylinder is a virtual volume, which is created from the motion of the blade. Therefore, although it is real, it doesn't have existential truth and was formed by motion; then it is virtual.

Following this observation and the subsequent discussion, we raise some other questions: Does the world around us (the universe) have reality of existence? Surely the answer is ‘yes’, because we exist and we can observe the world. Does the universe have also truth of existence?

To answer this question, we examine the structure of the universe very briefly within the scope which so far has been possible to understand and investigate. As we know the world around us (the universe) is made of Matter and Energy.

First we consider the material part which includes the cosmic bodies and we study their structure. These bodies are made from molecules, and molecules consist of atoms. Atoms in turn, are made of elementary particles as well as their anti-particles. This manner of succession continues until negative infinity inside the atom core.

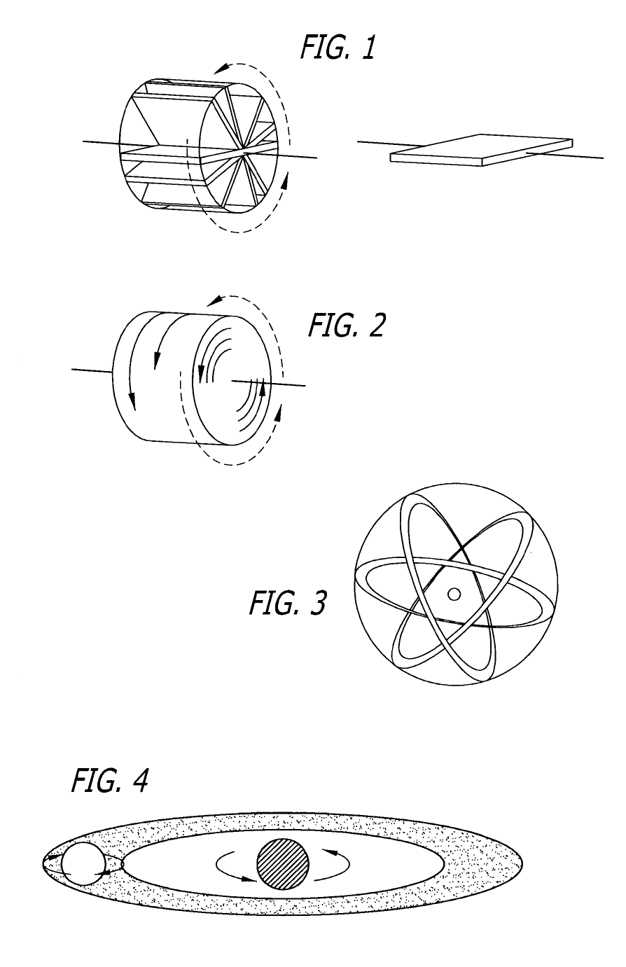

Now we study an atom as the building block for the structure of the creation. To examine more precisely, we suppose an atom to be as the size of a football field, so the atom nucleus (in comparison to the size of the atom) would be as the size of a ball (FIG. 3). If we observe this atom from a farther distance, it looks like a giant sphere.

Now we raise some questions: What causes the form and the volume of this giant sphere? This volume results from movement of the electrons, which is called ‘Electron Cloud’. Does this huge sphere have existential reality? Surely the answer is ‘yes’ because the sphere has been created and is real. However, does it also have truth of existence?

As soon as the electrons stop moving, this volume which has been resulted from movement of the electrons disappears before our eyes in a second and only the nucleus as the size of a football remains. Therefore, we conclude that this volume does not exist in the outer world, but it is the result of motion and is therefore virtual.

Now, we study the nucleus of an atom in the same way. As we know the nucleus of an atom consists of protons and neutrons. In FIG. 4, proton spins around its axis. The neutron also spins rapidly around the proton, which spins in the opposite direction. Consequently, the spin of neutron around proton produces a disc that is a virtual volume.

Now if protons and neutrons stop spinning, this volume also disappears and from the whole atom whose volume is considerably less than before, just the elementary particles are left.

In the manner, if we continue to penetrate the particles inside the nucleus and stop them from moving in different levels, we will see the volumes created by these particles, disappear one after the other without a trail. In summary, a collection of infinite elementary motions form the nucleus of an atom and the atoms form a molecule and from molecules the material part of the universe has been formed. Accordingly we can say that the material universe is made of “motion.”

We can reach the same conclusion from another perspective: In modern physics, matter is defined as condensed wave, and wave in turn is considered as motion. So the whole material universe (be it matter or energy) has been made from wave. As it was said before wave itself, is caused by “motion”. After this brief and simple explanation, now we can answer the question of “Whether the universe has truth of existence or not?”

The answer is whilst the material universe has been created from motion, all its different manifestations also result from motion, and as explained before, all the manifestations of motion is virtual, and therefore the material universe is virtual and lacks existential truth. After understanding that the material universe has been created from motion, we consider another question: Which prime factor has given direction to these infinite motions in the universe in such a manner that in the midst of the all these innumerable motions, a completely harmonized and purposeful system has been manifested?

The answer is the only cause which is able to direct the infinite existing motions so purposefully, is an intelligent and conscious cause, which is capable of deciding each motion, in which exact direction, and in which exact manner must take place in order to finally create such a purposeful, harmonious and self-evidential system. Hence, matter and energy, in order words, the basis of the universe, is made of intelligence, awareness or consciousness. The material universe has been created from consciousness or intelligence.”

For instance, without awareness, the human being is not capable of exploiting matter and Energy. It means if matter and Energy would be available to human, without awareness and information he would not be able to use matter and energy purposefully. Therefore, the ultimate structure of the material universe is intelligence or awareness from which matter and energy are formed.

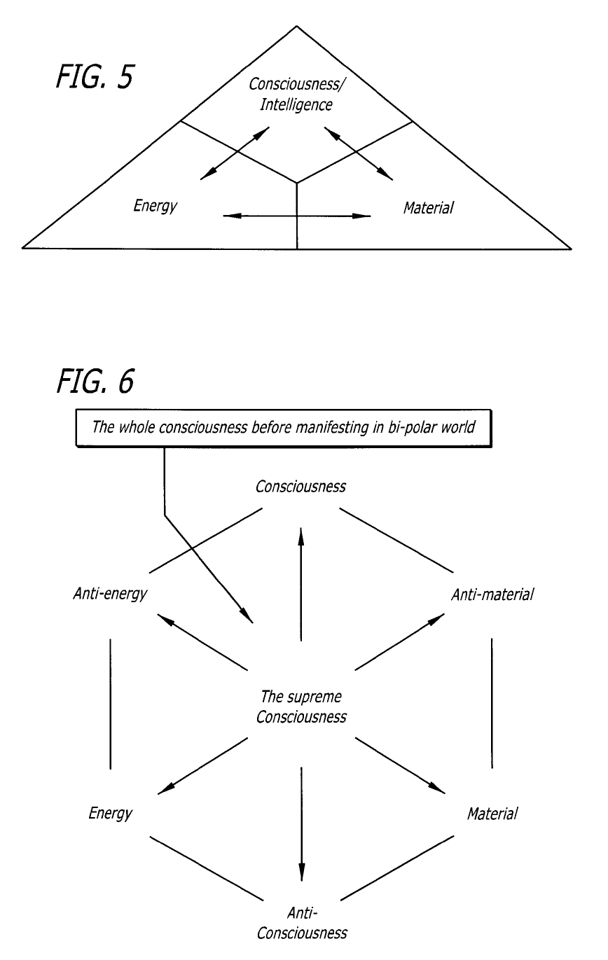

As FIG. 5 illustrates, each of the above elements is convertible to one another. The conversion of consciousness to matter and energy has been briefly discussed, however the conversation of matter and energy into consciousness is a complex and all-inclusive discussion, which we intend to discuss separately.

The schematic FIG. 6, examines the particles of the universe more closely. It illustrates all the elements of the material universe which exist in a given time simultaneously: The world visual image based on velocity of the observer

Let's consider an observer who is moving in the space with a certain speed. As we know, when it gets closer to, or moves away from a sound or light source, the frequency and wavelength of the sound/light changes. For example, by getting closer to a sound source, the wavelength of the sound gets compressed and becomes shorter, therefore the frequency of the sound increased. As the result the perceived sound is at a higher pitch. In contrast, by getting farther from the source, the wavelength becomes decompressed and longer, the frequency decreases so we heard a lower pitched sound or bass (Doppler Effect).

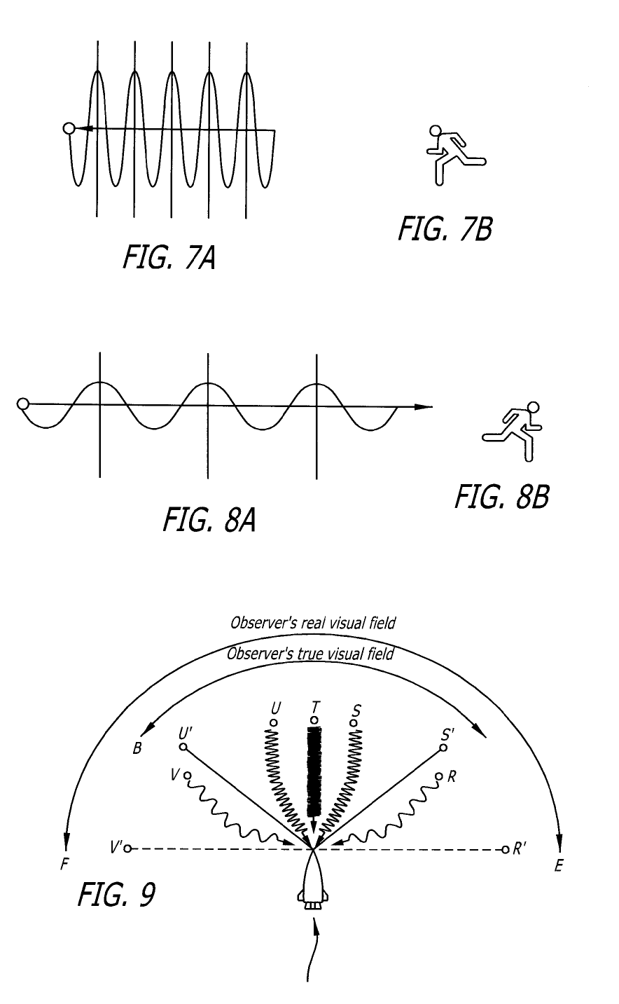

The same applies to a light source. By getting closer toward or farther from the light source, there is a frequency change therefore the color of the light and its appearance changes (FIG. 7).

FIG. 8 shows that by getting further from the source of sound or light, the wave length increases so the frequency decreases and the sound is heard more bass.

Again we consider the hypothetical observer and what he observes before his eyes: It is apparent that as the observer speeds up, the view in front of him changes, therefore in a given velocity the world in perceived as a certain visual image by the observer, and the world will appear differently to him if he moves at a different velocity. At the moment, we see the world's panorama the way it is because we are moving through space with a near constant velocity. Given that planet earth is a part of the solar system and is revolving with a near constant velocity around itself and around the sun. The solar system in turn is located at one of the arms of the Milky Way galaxy and is also revolving around with a certain velocity. This galaxy itself is rotating in space with certain velocity around another centre. After all, our perceived view (in regards to appearance and different color ranges) is based on the ultimate velocity of our movement within space.

In addition, at significantly higher velocities, the view that the observer perceives is considerably different from what we see at the moment. At the moment we see our surroundings very easily, however, as the velocity of our movement increases, the angle of the scenery in front of us narrows, in a way that assuming if we could travel at the speed of light, (in theory) as an observer all that we could see would be a tiny hole-like “opening” before our eyes, nothing else!

The reason is by the time the light (which is emerging from the side sceneries) reaches the point we are now, we have already moves past that point. Therefore, the light would never get a chance to reach our eyes thus our surrounding could never been observed.

Moreover, the frequency of the “opening” would reach the infinity and it is not clear what could be observed through such a hole and how the world would look through our eyes (regardless that when the wave is condensed enough, Matter will form, thus transforming the condensed wave to matter at a velocity high enough to create a barrier in front of us which is impossible to pass through. Therefore, an observer who travels at the speed of light sees the world as just a “hole” with an infinite frequency. At the time this would be the reality of his world. If such an observer has never seen the reality of our present world before, then he definitely cannot perceive or even imagine how the world looks like as we are able to see—in fact he would not be able to conceive any other reality expected for the world of “hole”.

As can be seen in FIG. 9, when the observer looks at his right hand side and observes the star R′—in fact star R′ is situated in R position. Therefore the observer faces two different visual fields, one is the real visual field (FE), and other is the true visual field (AB).

The real visual field angle is the angle that the observer practically observes in front of him in respect to the observed object, and the True visual field angle, is the angle that the actual true location of the object forms relative to the observer. Now as the observer moves faster, the visual field angle AB and EF decreases, in such way that at the speed of light, nothing is observable backwards and the compressed wave with infinite frequency appears forward in front of the observer. In summary, the wavelength of energy (light) in very high velocities gets so condensed that it creates a compressed wave in front of the observer thus forming a barrier (which is essentially Matter) in front of him.

In this particular condition, the world will become very solid or dense and regardless of which direction he intends to move, a condensed wall will block his way. Therefore the world can be considered as both finite and infinite.

As soon as the observer hits this barrier and ceases to move, the frequency in front of him will subside, and it will transform (from the condensed form of Matter) into a non-condensed form of wave and once again, as the observer speeds up, everything repeats. Consequently:

The human's velocity in the space cannot go further a certain limit. It is impossible to travel continuously in space at velocities of this magnitude (FIG. 9). Thus we can conclude that the universe has an infinite number of appearances, and each observer sees it in a certain way depending on their velocity in the space. So it is possible that other realities exist that we cannot even imagine or dream of.

Does the universe possess a main distinctive appearance then? The material universe does not have one steady or main appearance. Its outlook depends on the speed of the observer and as the observer can have countless different velocities, potentially there are infinite possible appearances of the material world for each observer.

Each observer looks at the world with his own eyes. The eyes of each observer have a particular frequency which indicates the number of frames per second that they are capable of receiving and interpreting. In human, the eye appears to be most sensitive to frequency of 24; meaning when 24 frames pass before our eyes in one second, we see them as ‘continuous’. If the frequency of the frames is less than 24, the scenery before us seems interrupted and ‘non-continuous’ (the basis of invention of cinema) and by increasing the frequency of the frames, the scenery seems to move abnormally fast. Eventually at the higher speeds, frames would become unrecognizable.

Therefore if human sees the world in this form and appearance, it is because of the frequency of his eyes and if this frequency were a different number, the scenery of the world would appear to him differently. For example, if an object such as a ruler rotates at the speed of 50 times (cycle) per second, what human sees is a ‘circle’. However if the eye frequency of an observer were the same as the ruler 50, he would perceive the movement of the ruler as ‘steady’ so he would not see the circle at all. All he would see is the relocation of the tips of the ruler 50 times per second.

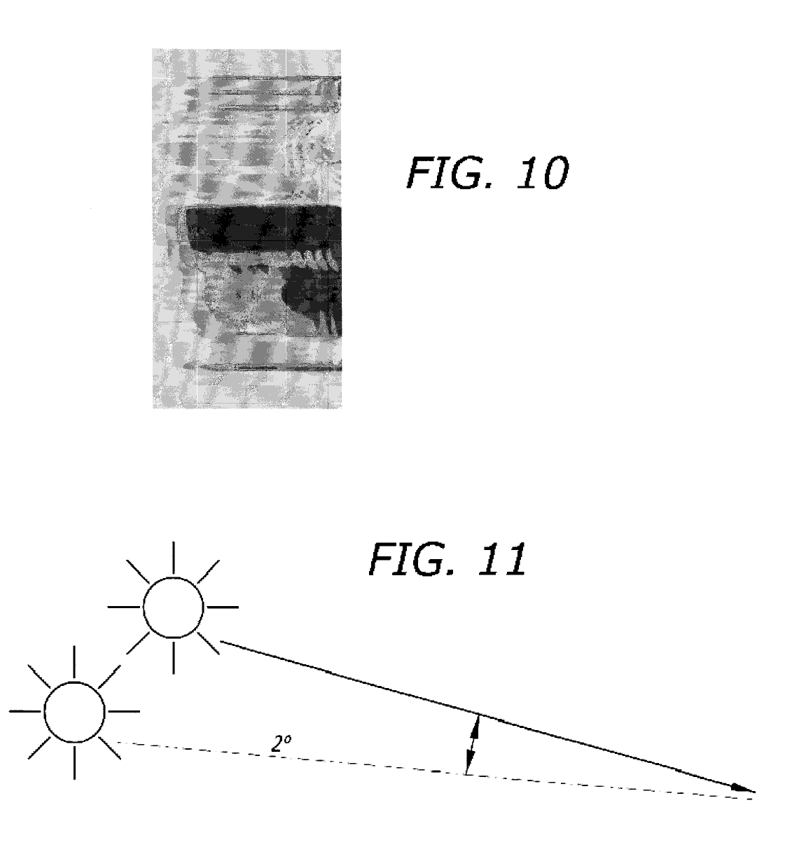

The scenery of which an eagle sees with an eye frequency of 20,000 is totally different from what a human sees. An eagle can chase the movement of mosquito with full concentration in every second whereas human is not able to do this. This eagle would see the rain as “drop by drop”, while we observe it falling as linear. Another example is the snail with eye frequency of 5; whatever a snail actually sees at such a frequency would be very strange and bizarre. For instance, when we are moving, the snail sees a trail of several meters long behind us (FIG. 10). Only when we completely stop, the snail sees us in the shape we are. If the snail were to see a mosquito flying past, then it would see a very long random trail.

Whatever appears before an observer's sight is the result of continuity of the frames. If the frequency of the observer's eyes increases, the continuity of the scenery before his eyes diminishes to such an extent that if the eyes had an infinite frequency, the continuity would completely disappear.

In such circumstances the observer would actually see ‘nothing’. This is because the electron movements and different frequencies are perceived as static and still. Since the electrons and continuity, the scenery of the world would disappear from the observer's sight as the frequency of the eyes gradually increases toward infinity.

So, in view of the observer's eye frequency, the world has again countless view and depending on the magnitude of this frequency, it can appear in a particular way, and does not possess a certain outlook and is essentially virtual.

The material universe does not possess a definite view and appearance, and each observer perceives it according to his velocity in space and his eye's frequency. Every eye is designed in a way to reflect the world as a particular figure to his owner, so it merely conveys a virtual figure resulted from spinning of the (atomic) particles to the observer.

Each observer depending on his physical perceptual threshold sees the world in a different way. For instance, what snakes can see is completely different from humans because the threshold of perception for snake is different from human. For example, snakes can see infra red light. Therefore snakes have very acute eyesight during the nights and darkness is almost meaningless for them and day or night does not make a real difference. They are also capable of seeing the temperature of the objects and living creatures; therefore what they see as the world, is different from what we are familiar to and we know of. Now. Let us imagine snakes were to express their view about the world and describe what they perceive. It would be definitely very different in comparison to our view and we would strongly disagree with each other. A bat views the world as a confined Sonogram map. A bat can only see up to a limited distance, proportional to the scope of his vocal sound waves.

The bat's visual image of the world is not comparable at all with the scenery that humans perceive. Bat's ultra sound radar system can cover a limited territory. If we could talk to a bat about the boundless world, he would certainly laugh at us and find it ridiculous: “how it could be possible for the world to be infinite!”

In summary, the diversity of the perceived views of the world is proportional to the number of the living things (from microorganisms to all the creatures in the whole universe). Therefore, also from this angle the world has indefinite outlooks, and each observer depending on his sensory receptors sees it differently, which of course none of these are true.

Accordingly all the sceneries of the universe are virtual and none of them is true, given that if we ask “which creature sees the main scenery of the world?” Each creature depending on his threshold of physical perception has a certain idea about “how the material world looks like”; therefore there are infinite appearances for the world.

When we look in the sky at night, we see a beautiful view in front of us. We see so many stars that they overwhelm us with their magnificence. Is this scenery before our eyes true or is it visual? The answer is what we observe at the moment, is the virtual image of something that used to exist in this position in the past. None of the stars that we observe are actually located in the position that we see them now; this implies to the nearest star which is the sun, to all other stars and galaxies belonging to several billion years ago (FIG. 11). For example, what we observe as the sun is actually from 8 minutes ago.

If we seen an object one meter away from us this image belongs to 0.33×10⁻⁸ seconds ago. Therefore all we see are virtual perceptions, and the speed of light is no more than an illusion. Therefore, we cannot rely on our observation in this scene, and whatever we know and have perceived as the world is essentially virtual.

As we know the straight line in space and each moving object is travelling through an orbit in space. In other words, space is spherical and layered. Each mobile object that wants to have free movements in space must be located in one of these layers and travel along this orbit. But if it intends to change the curvature's direction, it has to use energy.

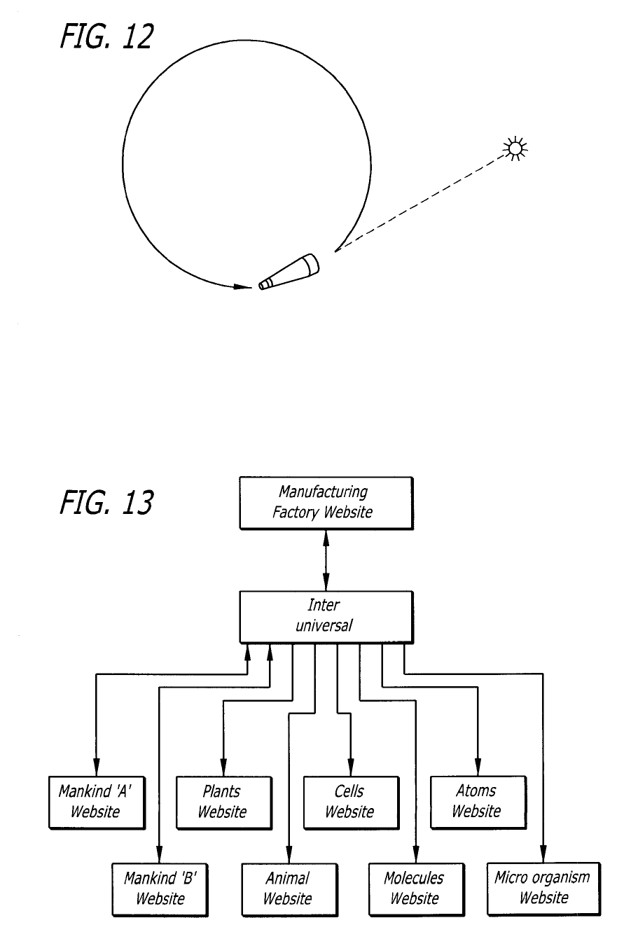

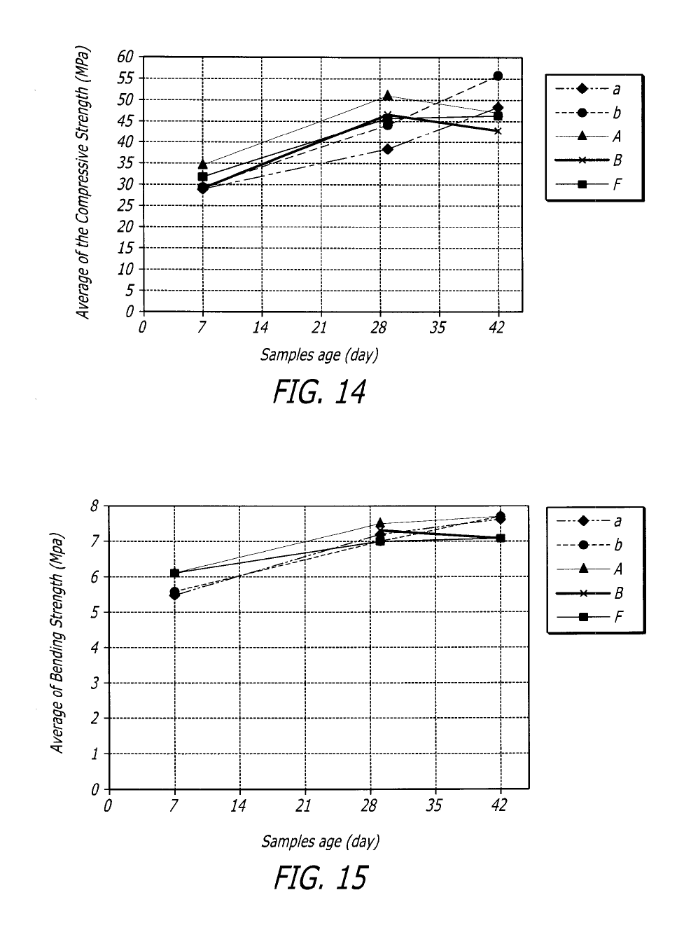

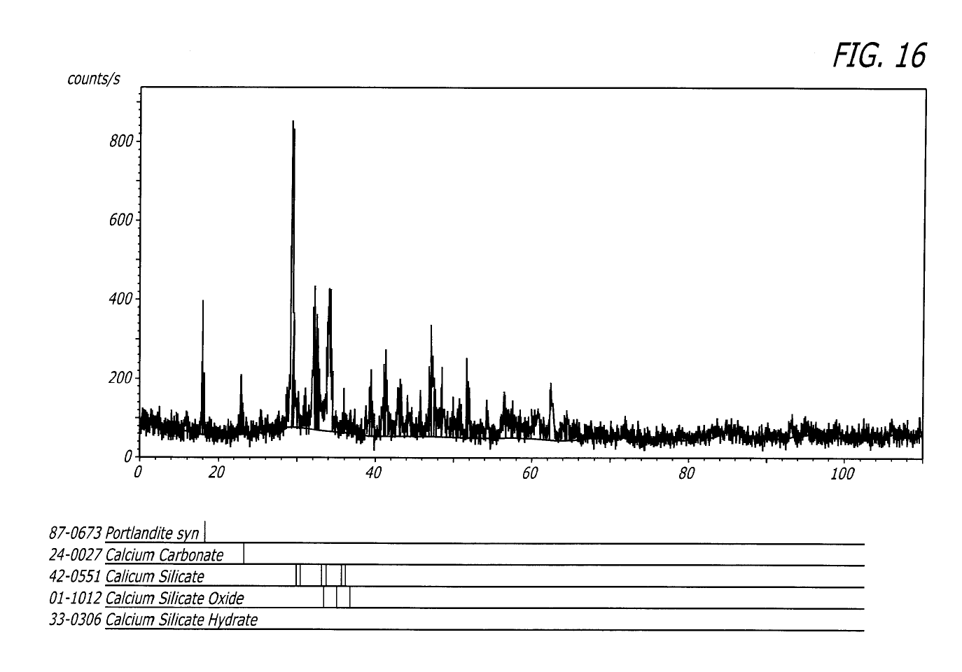

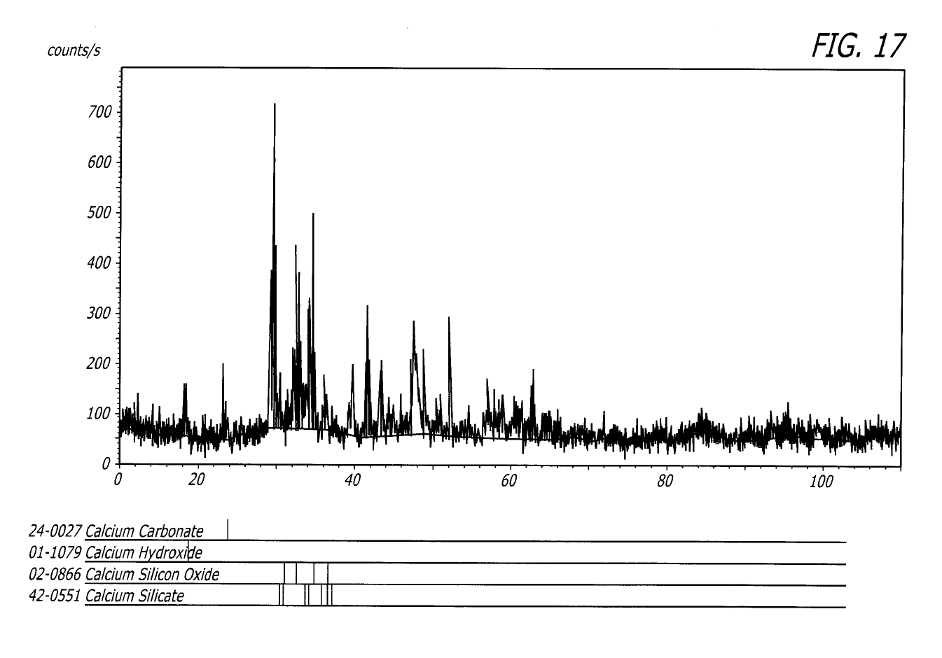

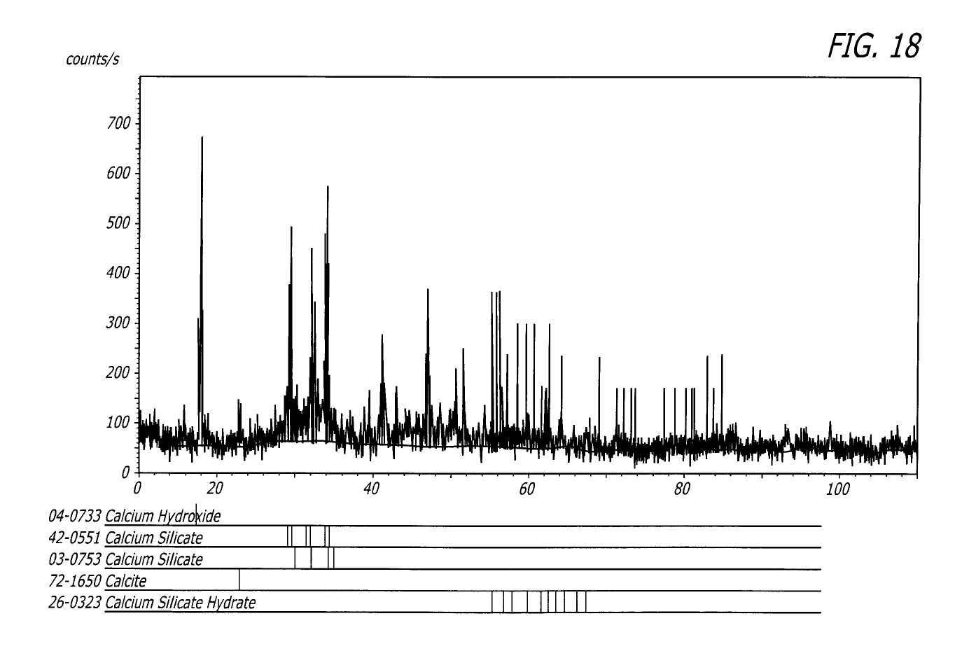

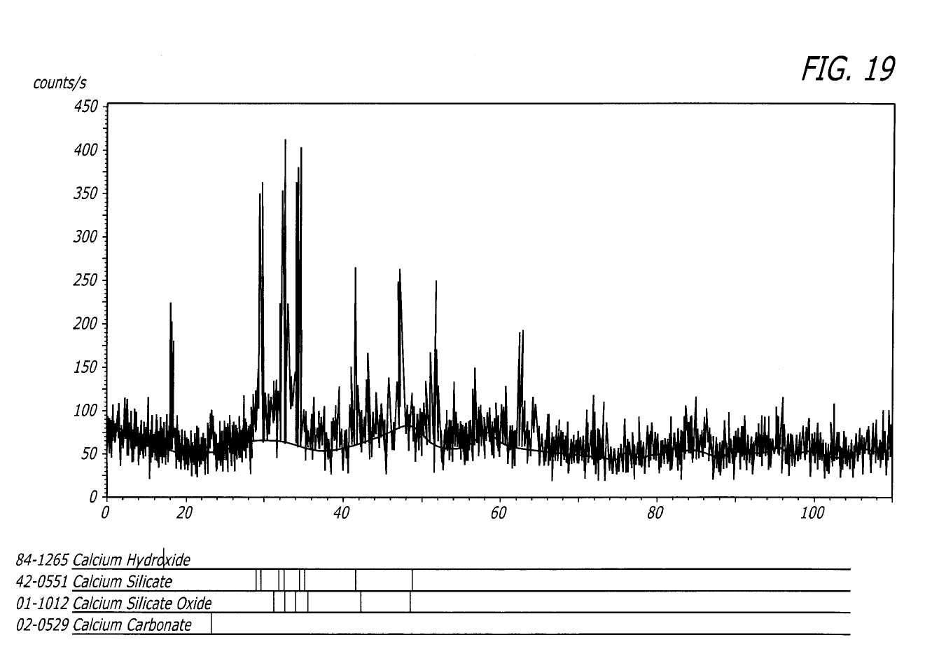

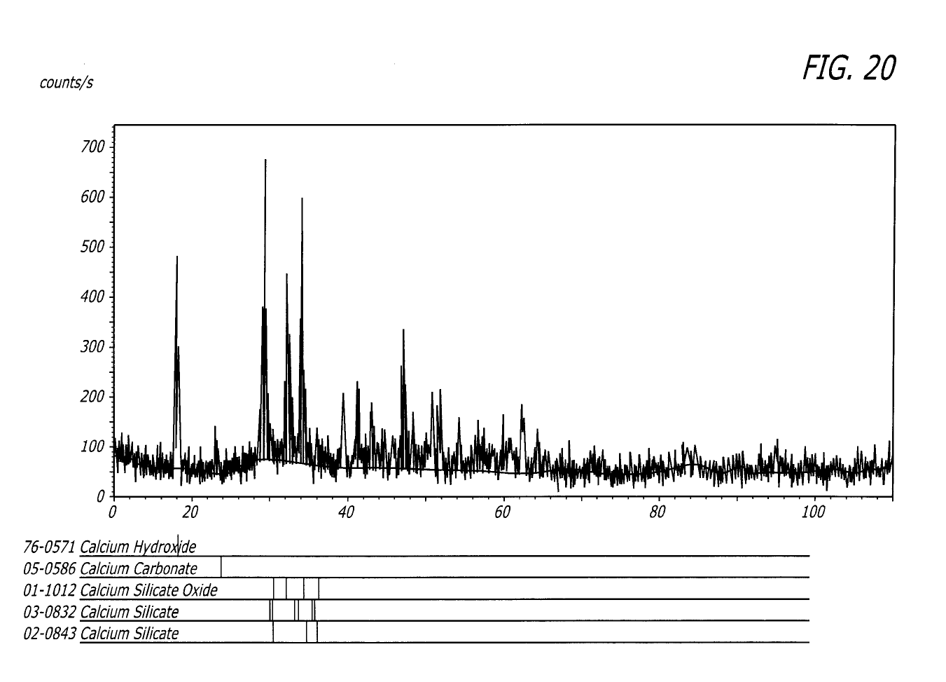

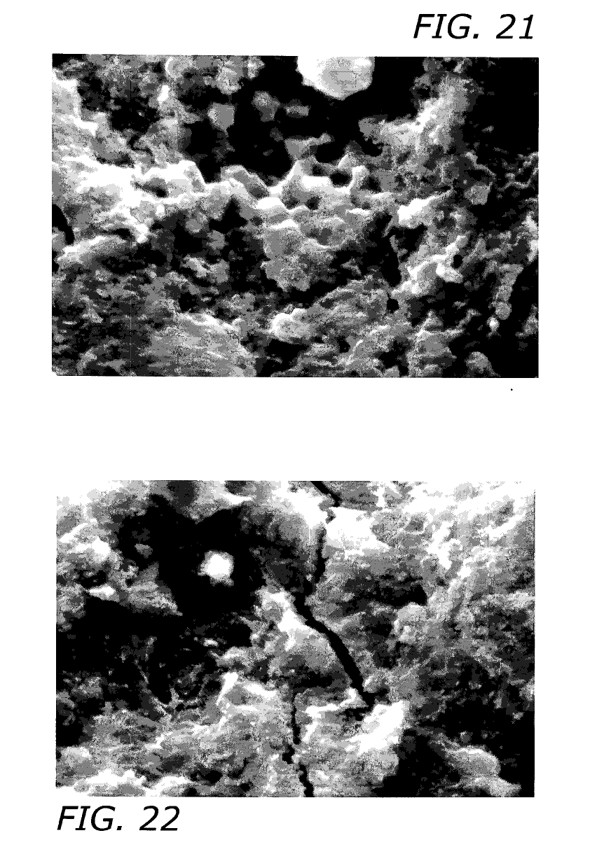

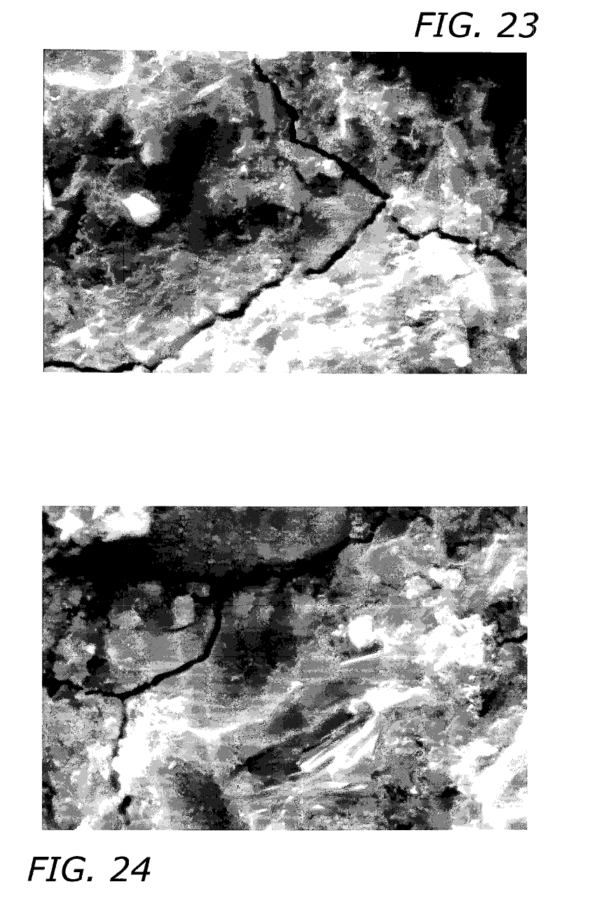

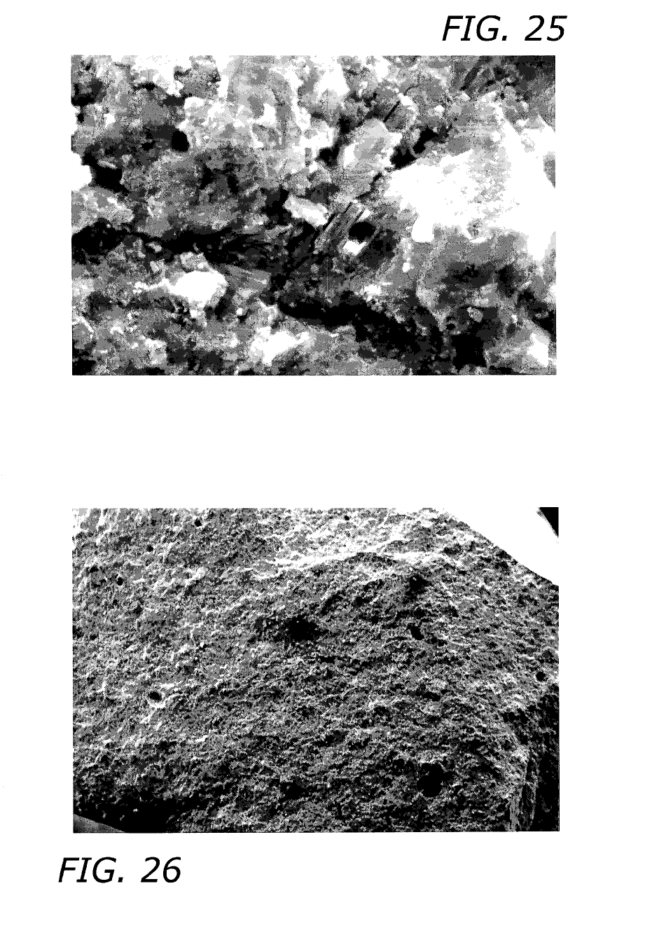

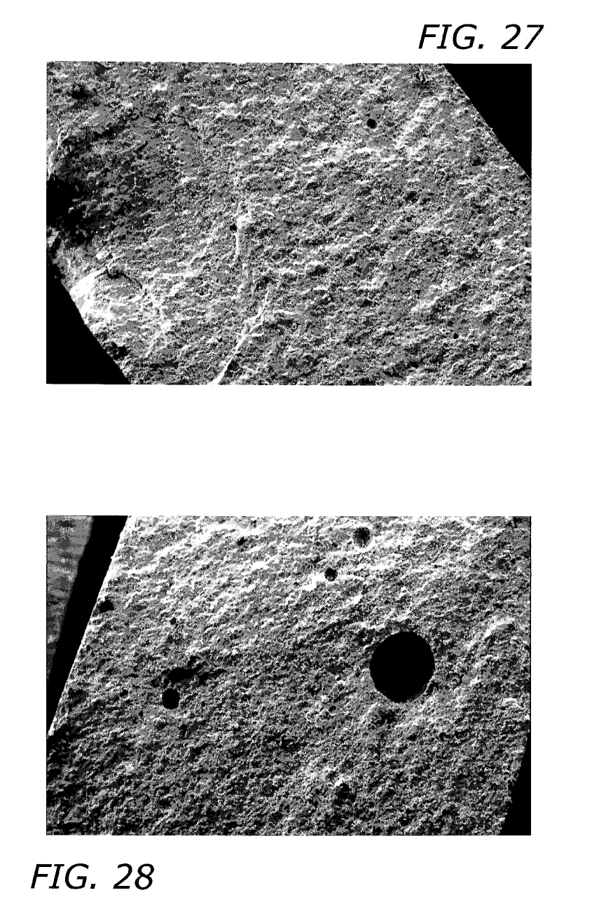

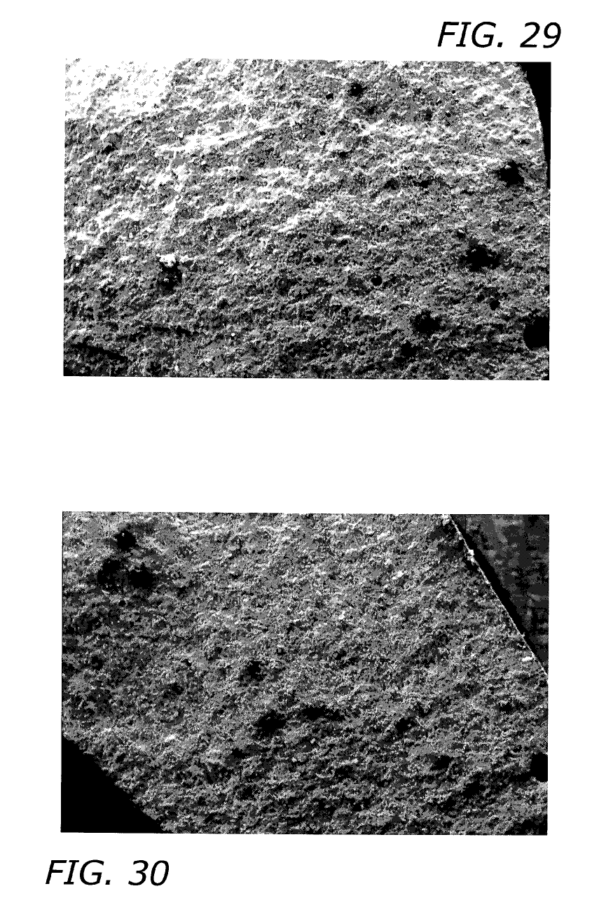

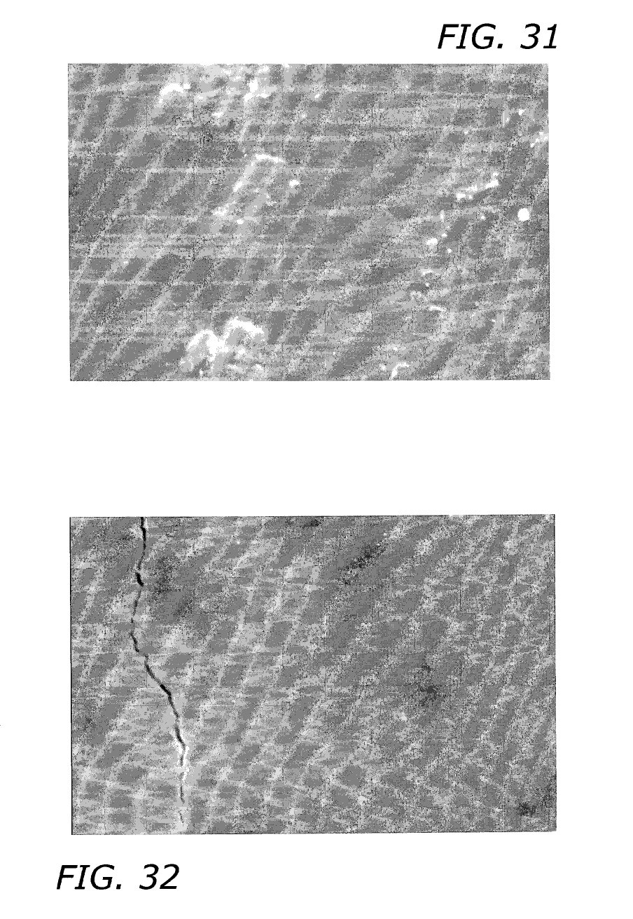

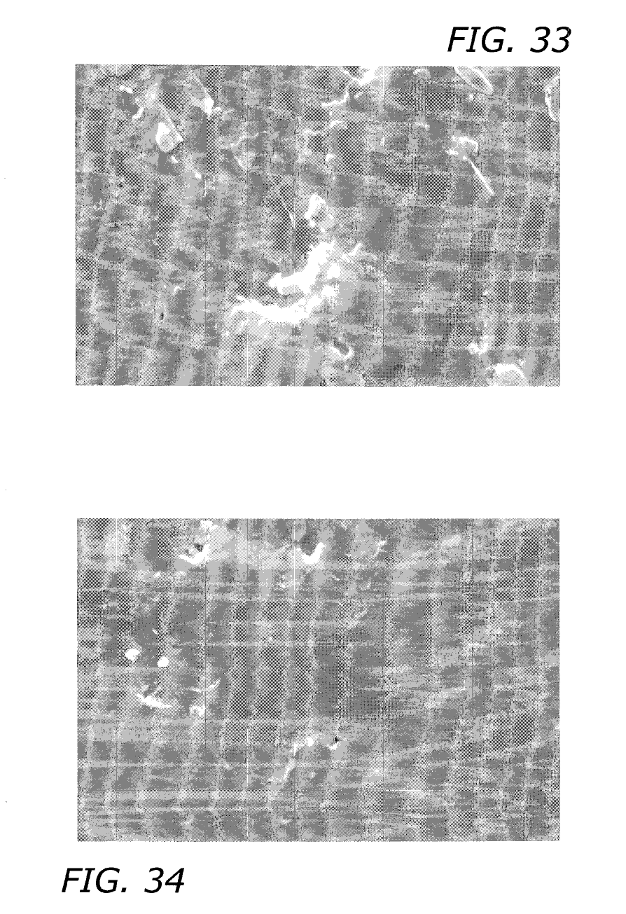

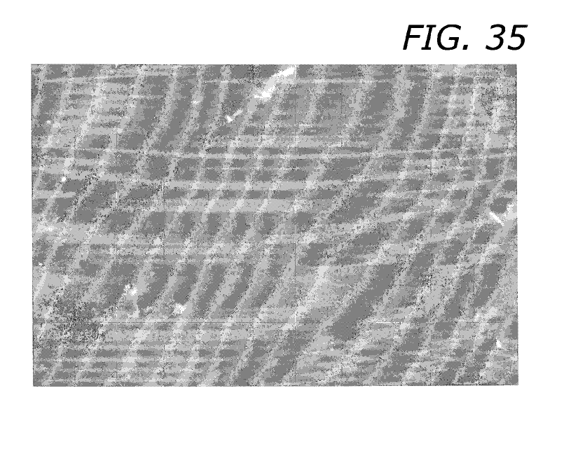

Now, if an observer were to look in to the sky through a telescope with infinite power, what would happen? First, the maximum visible distance would be limited to the radius of a giant circle and the world would look like (FIG. 12) confined to this circle. Secondly, as he would see the side of the object, up to the point at the maximum viewable distance, instead of seeing the front of the object, he would see its back.

Referring to all above brief discussion, we conclude that from any angle we see the universe, it is virtual and in fact each illusion is embedded inside infinite number if other illusions.

As it has already been proved, the material world of existence has been created from consciousness or awareness. This consciousness has created the primary motion and has given direction to it. Space and times has been created by primary motion, giving birth to energy which in turn has caused further temporal and special changes.

Energy is divided into two general categories “compressed and decompressed”. It is worth to mention that essential energy itself is frequency and motion, and as it has already been discussed without the presence of intelligence and consciousness, no motion can possess direction and purpose.

Energy is formed in the presence of “consciousness field” and without the presence of such a field no form of energy can exist. Therefore the material world of existence has only one dimension and what human being knows as different dimensions; such as tri-dimensional space and fourth dimension (time), all make sense only within and in the vicinity of this consciousness field; and as a matter of fact they are all created within this field.

Currently, in the world of science and in Modern Physics (Quantum physics), it is the ‘observer’ who determines the structure of the world of existence for instance whether energy appears as wave or appears as particles, depends on the observer.

The old perceptive (the view of the classic Newton Physics) had settled this mentality that whether the observer be present or not, the world of existence has a definite and indisputable reality, sustain its own independent form, shape and nature, and continues to exist regardless, so this is not the eyes of observer that determines the scenery of the world.

However on the contrary, in modern physics it is the observer who determines how and in which form a reality appears; whether all the world of existence appears as wave or as a composition of particles.

Thus, theoretically it is proved that a massive consciousness is governing the universe whose all particles are under the control and guidance of this consciousness. This consciousness acts exactly like a widespread internet network so, we call that the ‘Inter universal Internet’.

According to FIG. 13, users can connect to the ‘Inter universal Internet’ in order to receive their existential catalog from the manufacture's site to exploit form that for their self-analysis, or in this connection, with taking this network facilities for treatment of themselves or others and witnessing of the unbelievable treatment. (This example is used for understanding the importance and effect of man relationship with his creator and nowise, its purpose is not to liken God to a factory).

It should be noted that cure and recovery include all software programs relating trouble recognition, recovery and improve of cells, organs, which are present in the Interuniversal Internet. As mentioned, since software programs of all particles of Being are available on this great Internet, we call it ‘Interuniversal Consciousness’. Thus, for the ‘Interuniversal Internet’ there is no differences if cells belong to humans, animals, plants or micro-organisms and through it, even effect on the molecules is also possible.

We know that any particle in ecosystem is under different fields such as gravitational, magnetic and nuclear fields, we also know under each field the particle shows specific behavior. These are known to the current scientific world. However, under the ‘Consciousness Field’ which can be applied through the ‘Interuniversal Internet’ behavior of any particle complies with some other rules and regulations. Thus particles can be formed, analyzed, combined and recovered in some specific ways. And depending on which group including cell, human, plant and molecule, put under the ‘Interuniversal Consciousness’ the changes will be done based on specific rules and in the specific respects. For instance whenever organs and cells are put under the ‘Interuniversal Consciousness’ their change of behavior will result into improvement of functions in the following ways: (1) Recovery and Improvement: (a) Histological (tissues recovery), (b) Functional (recovery and improvement in functions of cells and organs), (c) Morphological (recovery and improvement in form and size), (2) Recovery and Improvement of the cellular and organic exhaustion, (3) Recovery and Improvement of disability, (4) Recovery and Improvement by changing at the non cellular organic level, such as opening coronary vessels, osteophyte treatment, dissolving kidney stone, which all have molecular structure, and (5) Recovery of Software programs.

The above mentioned changes of behavior under the ‘Consciousness Field’ have been basis of many cures and research on cells, plants, animal. On the other hand, in the item 4, organic non cellular recovery, all cases are molecular masses existing in the animates bodies showing behaviors in direction of being analyzed, under the ‘Consciousness Field’. If particles and molecular structures are put under the ‘Consciousness Field’ with an engineering and material science approach, they show formation, analysis, combination and recovery in direction of better manifestation of their own fundamental characteristic.

If some material is hardening by its nature, having been put under ‘Interuniversal Consciousness’ makes the material show better behavior in direction of more hardening. Or if some material is antibacterial in its fundamental characteristics, it will show better behavior in this direction (antibacterial behavior).

As we know technology and engineering sciences are dependent on the particles and materials behavior and characteristics. Better utilization of material characteristics has been always of researchers' and industries' interest. What improves material function will also improve function of the products using fundamental characteristics of those materials. Indeed, impacting by the ‘Interuniversal Consciousness’ and the ‘Consciousness Field’ is part of future human technology which can improve function of many materials and products without using complex equipments and very specific situations and also without making environment polluted. Thus all structures including particles, molecules, catalysts, Nano materials as well as the products which use those structures fundamental characteristics and composites, each as an organizational unit has a specific characteristic which will show better behavior in direction of its own fundamental characteristic. Study of how the particles and materials behavior improve can be beginning of vast researches in addition to the technological and industrial applications it has. Establishment of the ‘Interuniversal Consciousness’ through the “interuniversal Internet” will be part of future human capability knowing and using quite new technologies in order to impact our environment and better knowledge about Existence.

Experiences out of using the ‘Interuniversal Consciousness’ shows that the Universe is a fabric, alive and targeted entity.

Through the ‘Interuniversal Consciousness ’ there is possibility of connection to and influence on all particles of the universe without passing time and space. This influence is dependent on the nature and fundamental property, i.e. the fundamental characteristic of that particle. In other words, through an ‘Interuniversal Consciousness’ or ‘Interuniversal intelligence’, one can access to each particle as an internet site, and create the specified and defined influence.

The way of manifestation, presence and behavior in ecosystem is ‘characteristics’. In other words, ‘characteristics’ is the software based on which each element of the universe is manifested. The practical way of manifestation, presence and active cooperation in ecosystem of each element is called ‘behavior’. So, ‘characteristics’ encompasses all factors and behavioral software showing all specifications of a member in ecosystem. Using ‘Inter universal Consciousness’ shows that the universe is a fabric, alive and targeted entity.

There are four Consciousness Fields applicable to matters, Faradarmani, Non organic Faradarmani (defensive radiation), Purposeful Faradarmani:(shared mind), and All radiations together.

Faradarmani is a consciousness/intelligence/wisdom joint of parts. When consciousness of some part, e.g. matter, cell is joined to the Whole Consciousness, i.e., the Interuniversal Consciousness/Interuniversal Internet having all information of the Universe, can investigate function of its own parts. That is, through Consciousness Field of Faradarmani the considered matter is investigated by the Whole Intelligence and required changes are done to improve the matter behavior.

For implementing Faradarmani a connected person needs just to put a considered matter in the Consciousness Field of Faradarmani. The moment his Nazar is executed to the considered matter, it is put in the Consciousness Field of Faradarmani and consequently will manifest better behavior.

As mentioned in order to create the Consciousness Field a very short announcement is sufficient since consciousness/intelligence/wisdom is independent of time and space arid can be implemented within zero second, i.e. needing no time.

Generally speaking other types of Consciousness Fields are the same in terms of the way one can implement them as well as the way the Fields can have their own particular impacts.

Non organic Faradarmani (defensive radiation) relates to non organic viruses which exist in the Universe and have effects on it. They can be present at matters and impact on them as well. In this Consciousness Field the matter is cleaned of the Non-organic viruses which may be present at matters and so impact on them. If the Non organic viruses have effect on a particular matter after their removal through putting the matter in this Consciousness Field, the matter behavior will improve.

Another Consciousness Field applicable to matters is Purposeful Faradarmani:(shared mind). In this Consciousness Field a purposeful consciousness message is also included. The message can be for instance “improvement of the matter structure”, or “change of the molecules form”, etc. That is a related specialist can announce an awareness message for the matter according to the molecules changes which can result into betterment of the matter and thus create a special Consciousness Field.

Applying all three above mentioned Consciousness Fields simultaneously is called all radiation.

In all of the four Consciousness Fields the matter behavior will change in direction of better manifestation of its fundamental characteristic. The changes can be investigated from four aspects: Change of form and arrangement of the molecules have happened. Chemical compounds has happened. Some elements are composed in the Consciousness Field which used not to be done previously. Chemical analysis has happened. Some elements can be analyzed in the Consciousness Field which could not be done previously. Structure rehabilitation has happened. The structure can be rehabilitated in the Consciousness Field while it could not be done previously.

### Experimental Section

In the experiments on cement a connected person has announced the four Consciousness Fields to the cement samples already made and named by the lab personnel. The connected person has chosen which field to be applied to which sample. It should be emphasized that the Consciousness Field is quite independent of feelings, sentiments, moods, and names.

Thus in each experiment the samples have been named differently. Indeed the person in charge of making and measuring the samples in each experiment has given just some names to the connected person and then he has applied one of the fields to one of the samples. In one experiment the lab personnel in charge of making and naming the samples has used capital and small letters, in another experiment he has used figures and etc.

All experiments were done under the same situations and using the same equipments.

The sand used in the whole project enjoyed all requirements of the Iranian National Standard 3040. The cement used in the whole project was type II. All used materials were provided through one single order. The cement was homogenized as much as possible before being used. The water used was distilled water. Temperature of the laboratory was 20±2 Celsius, the humidity was at least 50% and temperature of the used water was 20±1Celsius.

Temperature of the cement and all equipments was 20±2 Celsius. Precision of the scale was ±1 gr. All samples which were to be kept in a moist environment for a specific period of time were kept in an environment with humidity of higher than 90% and temperature of 20±1Celsius.

Temperature of the water into which the samples were dived to the considered age was 20±2Celsius. It was drinking water. All measurements and samples preparations were done with the same equipments and under equal conditions. In order to decrease statistical mistake in the process of all of the three experiments, the control sample was made and measured among the whole samples.

The ‘Consciousness Field’ Was applied from the very first moment of the samples preparation. It is worth mentioning that the ‘Consciousness Fields’ are taught in courses of Faradarmani' which has been founded in Iran more than three decades ago. After passing the theoretical practical courses one will be capable of switching on the ‘Consciousness Fields’ and applying them. Persons who enjoy connection to the “Interuniversal Internet” can cause and apply the “ Consciousness Field.” The inventor is the one who has first been connected to the “Interuniversal Internet” and able to make others connected as well.

The study done on cement has been the first laboratory based application of the ‘Consciousness Field’ on materials. Indeed it's been the first industrial utilization of the facility.

Preparation and Measurement of the Cement Mortar Strength

In order to prepare the cement mortar for the study a mixer with international standards was used. The mixer was made of stainless steel, with capacity of 5 liter.

Its blade, made of stainless steel, included the main axis so that the blade spun around the axis on a plate. There were two different directions of spinning the speed of each one was not different from the other one more than 1 rpm.

| Rotation | | |
|---|---|---|
| per minute | Rotating Movement | Orbital Movement |
| Low Speed | 140 ± 5 | 62 ± 5 |
| High Speed | 285 ± 10 | 125 ± 10 |

The prepared cement mortar in weighted proportion—one portion cement, three portions of sand and ½ portion water—was filled in one mold each time. Each mold was composed of three horizontal chambers so that each time it could prepare three cubic samples with dimensions 160×40×40 mm. The mold was made of steel with thickness of at least 10 mm and hardness of internal surfaces of 200 HV.

450±5 gr cement, 1350 ±5gr standard sand and 225±1 gr water were required for each mold.

First the required water and cement were weighted and poured in the bowl of the mixer while being careful that weight of the mixture was not decreased. Then we switched on the mixer with low speed. After 30 seconds mixing, the sand was added to the mixture while mixing within 30 seconds. T hen increasing speed of the mixer we had the mixing procedure to be continued for 30 seconds.

And time 0 with approximation of minute has been base of the strength examination.

At the end mixer was switched off for 90 seconds. And within the first 30 seconds the cement mortar was gathered from the side and bottom of the container using a knife and put in the middle of the container.

Then again mixer was switched on with high speed for 60 seconds and so the cement mortar got prepared to be molded. Molds were fixed on the stroking table and in the first stage about 200 gr of the cement mortar was poured in the molds using a funnel. In each stage the mold was just once slowly pulled back and pushed forward to make the surface a little smooth and then by stroking device 60 strokes were given to the molds. In the second stage the cement mortar was also poured in the molds and again 60 strokes were given to them. Then the molds were taken slowly and the extra cement was removed from their surfaces using a ruler with almost right angle. At this stage the mold was named by the laboratory person responsible to make it and transferred to the moist environment. The whole procedure of cement mortar making and molding was equal to all samples. The samples were slowly taken out of the molds after 24 hours, taking time of their making into account, which was about minutes, and were fully dived into water horizontally. All samples were put into one single water container. The samples were taken out of the water container at most 15 minutes before strength measurement at each age. Then their surfaces were cleaned and covered with moist cloth till the time of test. Strength measurements were done at the ages of 7, 29 and 42 days.

### Bending Strength

In order to specify Bending Strength a three-point force loading apparatus was used. The sample was put in the apparatus and was loaded vertically with 50±10 Newton/Second by the upper roller on the opposite side of the cubic sample till the sample was broken. And by the time of the Compressive Strength test all broken parts were kept covered by the moist cloth. The Compressive Strength was calculated through the following formula:

Rƒ=(1.5Ff×L)/b³
Rƒ: Bending Compressive in Mega Pascal (Mpa)
b: dimensions of the square section of the cubic sample
Ff: the force loaded on the sample at the time of breaking in Newton (N)
L: length between center and the relying rollers center or loading opening in millimeter (mm)
The results of Bending Strength test were calculated and reported as the numerical average of the three individual results with approximation of 0.1 Mega Pasgal.

### Compressive Strength

Test was done on the samples broken in the Bending Strength test. Each half of the broken sample was put on the apparatus so that the transverse distance between the loading jaws and the sample lip was not more than ±0.5 mm. And the linear distance between the loading jaws and the sample end was about 10 mm.

The sample was slowly loaded 2400±20 N/S till it was broken. Compressive Strength was calculated through the following formula in Mega Pasgal. Rc=Fc/1600. Fc: the maximum of the loaded force while breaking time in Newton. Rc: compression strength in Mega Pasgal, 1600: area of the loading jaw in square millimeter.

The numerical average of the gained results was calculated with approximation of 0.1 Mpa having done six tests on three broken cubic samples.

Note: If one of the six results in itself is more than ±10% different from the average, that result is deleted and the average is calculated considering the rest five results. And if another result is also more than ±10% different from the average, the test needs to be repeated.

### Sample Preparation for XRD Analysis

In order to remember the standard conditions used to make cement paste and molds the whole procedure of the cement preparation and molding was exactly based on ASTM C121 standard with the proportion of water to cement (w/c) being 0.5 and the weighted cement portion being 650 gr. For making each sample, water was poured into the mixer and cement was added to it letting the cement to absorb the water for 30 seconds. Then the mixer was switched on with slow speed for 30 seconds and then it was switched off and kept off for 15 seconds. Then it was switched on with high speed for 60 seconds. The made cement paste was taken with hand and formed like a ball and was thrown from one hand top the other hand having 150 mm distance from each other six times. so that it became spherical and get into Vicat mold with the least hand touching. The cement ball was entered from the wider side of the ring and the ring was put on the plate from the bigger diameter. The over paste was removed slowly from the surface just with some slow movements and without any pressure on the cement. The Vicat mold was in the form of a ring, having an opening with internal diameter of 70±3 mm at down and 60±3 mm at up and height of 40±1 mm.

Then the samples were put in a moist environment for 24 hours and then taken out of the molds and kept in water for 7 days. On the 7th day, they were transferred to the laboratory for XRD test to examine hydration and carbonation of the cement, in phases CaCo3,C2S,C3S, and CH.

### Sample Preparation for SEM Photography

The cement paste with proportion of water to cement being 0.5 was made exactly like the previous ones. That is, 650 gr cement was made, exactly like what was done in the study II. However, instead of being poured in Vicat mold it was divided into 5 equal portions and put on a clean glass. The samples were kept in moist environment with humidity of 90% and temperature of 20±1°. Then the samples were transferred to the laboratory for SEM photography at the age of 28 days from two sides; joint to the glass and internal breakage

### The Results of the Cement and Cement Mortar

Increase in the samples strength under Interuniversal Consciousness, particularly at the age of 42 days, was observed. More percentage of CH (Ca(OH)₂) presence in XRD analysis at the age of 7 days in the samples under Faradarmani and Shared mind which suggests more suitable hydration. Although presence of CH in the samples under Defensive Radiation and All Radiation was not more than that in the control samples, cement elements (C₃S,C₂S) were not hydrated and more crystals were not seen. So we cannot absolutely say more suitable hydration has not occurred in the experiment sample.

In a suitable hydration phases C₃S and C₂S have react with water and produce CH and CHS gels. On the other hand CH can be composed with CO₂ of the air and produce CaCo₃ which will appear as mildew after water is vaporized. It also has some other bad effects on the cement.

In none of the sample under Interuniversal Consciousness C₂S, C₃S and CaCo₃ were seen more than the control samples.

Generally speaking based on the gained SEM photography result and General Connection theory cement under Interuniversal Consciousness shows better behavior in direction of its fundamental characteristics, i.e., Hardening.

### The Results of the Cement Mortar Strength

Table 1—shows the values of the bending strength and compressive strength in MPa out of the machine and the calculated average as well as percentage of the changes in comparison to the control samples at the age of 7 days.

| | | Bending Strength Test | | | Compressive Strength Test | | | |
|---|---|---|---|---|---|---|---|---|
| | | read Bending | Average | Percentage | read Compressive | | Average | change |
| sample | description | Strength (mpa) | (Mpa) | of changes | Strength (Mpa) | | (Mpa) | Percentage |
| B | control | 1.2 | * | — | 50 | 46 | 29.5 | — |
| | | * | | | 49 | 45 | | |
| | | 2.6 | | | 44 | 49 | | |
| A | All | 2.6 | 6.1 | — | 52 | * | 34.8 | 17.97 |
| | radiations | 2.8 | | | 57 | 55 | | |
| | | 2.45 | | | 58 | 56 | | |
| F | Faradarmani | 2.5 | 6.1 | — | 53 | 51 | 32 | 8.47 |
| | | 2.7 | | | 50 | 51 | | |
| | | 2.6 | | | 51 | 51 | | |
| a | Defensive | 2.2 | 5.5 | — | 44 | 48 | 29.1 | −1.36 |
| | Radiation | 2.5 | | | 46 | 48 | | |
| | | 2.4 | | | 46 | 47 | | |
| b | Shared | 2.2 | 5.6 | — | 47 | 43 | 29.3 | −0.68 |
| | Mind | 2.4 | | | 47 | 46 | | |
| | | 2.6 | | | 48 | 50 | | |

* As the control sample is out of range, percentage of the changes was not calculated

Table 2—shows the values of the bending strength and compressive strength in MPa out of the machine and the calculated average as well as percentage of the changes in comparison to the control samples at the age of 29 days.

| | | Bending Strength Test | | | Compressive Strength Test | | | |
|---|---|---|---|---|---|---|---|---|
| | | read Bending | | percentage | read Compressive | | | percentage |
| sample | description | Strength (mpa) | Average | of change | Strength (Mpa) | | Average | of change |
| B | control | 3.3 | 7.3 | — | 80 | 76 | 46.9 | — |
| | | 2.9 | | | 69 | 75 | | |
| | | 3.2 | | | 74 | 76 | | |
| A | All | 3.4 | 7.5 | 2.74 | 82 | 83 | 51.2 | 9.17 |
| | radiations | * | | | 79 | 84 | | |
| | | 3 | | | 81 | 82 | | |
| F | Faradarmani | 3.1 | 7 | −4.11 | 75 | 72 | 45.8 | −2.35 |
| | | 2.9 | | | 73 | 74 | | |
| | | 2.9 | | | 71 | 75 | | |
| a | Defensive | 3.1 | 7.2 | −1.37 | 59 | 57 | 38.8 | −17.27 |
| | radiation | 3 | | | 66 | 61 | | |
| | | 3.1 | | | 63 | 66 | | |
| b | Shared | 3 | 7 | −4.11 | 70 | 65 | 44.3 | −5.54 |
| | mind | 2.9 | | | 71 | 75 | | |
| | | 3.1 | | | 67 | 77 | | |

Table 3—shows the values of the bending strength and compressive strength in MPa out of the machine and the calculated average as well as percentage of the changes in comparison to the control samples at the age of 42 days.

| | | Bending Strength Test | | | Compressive Strength Test | | | |
|---|---|---|---|---|---|---|---|---|
| | | read Bending | | percentage | read Compressive | | | percentage |
| sample | description | Strength (mpa) | Average | of change | Strength (Mpa) | | Average | of change |
| B | control | 3 | 7.1 | | 72 | 74 | 42.9 | |
| | | 3.1 | | | 70 | 64 | | |
| | | 3 | | | 63 | 69 | | |
| A | All | 3.3 | 7.7 | 8.45 | 74 | 80 | 47.2 | 10.02 |
| | radiations | 3.2 | | | 70 | 77 | | |
| | | 3.4 | | | 72 | 80 | | |
| F | Faradarmani | 3 | 7.1 | 0 | 75 | 73 | 46.6 | 8.62 |
| | | 3 | | | 77 | 73 | | |
| | | 3.1 | | | 79 | 70 | | |
| a | Defensive | 3.3 | 7.6 | 7.04 | 79 | 79 | 48.6 | 13.28 |
| | radiation | 3.3 | | | 71 | 82 | | |
| | | 3.1 | | | 68 | 78 | | |
| b | Shared | 3 | 7.7 | 8.45 | 89 | 90 | 56 | 30.53 |
| | mind | 3.5 | | | 94 | 84 | | |
| | | 3.4 | | | 94 | 94 | | |

The XRD: for 7^{th} day-Control sample.
Sample Identification: SH: Control Sample
Comment: Exported by X'Pert SW
Start Position [°2 Th.]: 10.0100
End Position [°2 Th.]: 109.9900
Step Size [°2 Th.]: 0.0200
Scan Step Time [s]: 0.3500
Anode Material: Cu
Generator Setting: 40 Kv, 30 mA
Diffractometer Type:Xpert MPD

| | Height | d-spacing | | Area | Backgr. |
|---|---|---|---|---|---|
| Pos. [°2Th.] | [cts] | [?] | Rel. Int. [%] | [cps*°2Th.] | [cts] |
| 15.9129 | 6.20 | 5.56494 | 2.88 | 8.54 | 22.00 |
| 18.0932 | 103.52 | 4.89895 | 48.17 | 47.94 | 20.00 |
| 18.9290 | 6.40 | 4.68449 | 2.98 | 6.64 | 19.00 |
| 23.0880 | 21.09 | 3.84918 | 9.82 | 19.77 | 20.00 |
| 25.4897 | 10.09 | 3.49168 | 4.70 | 8.84 | 21.00 |
| 28.7863 | 21.98 | 3.09887 | 10.23 | 19.30 | 27.00 |
| 29.4484 | 214.90 | 3.03068 | 100.00 | 188.30 | 27.00 |
| 31.0393 | 13.09 | 2.87888 | 6.09 | 26.75 | 26.00 |
| 32.2902 | 85.97 | 2.77016 | 40.00 | 99.03 | 26.00 |
| 32.6452 | 73.37 | 2.74083 | 34.14 | 84.82 | 26.00 |
| 34.1109 | 89.15 | 2.62635 | 41.48 | 106.25 | 26.00 |
| 34.4697 | 54.14 | 2.59982 | 25.19 | 10.73 | 25.00 |
| 36.0414 | 29.46 | 2.48997 | 13.71 | 13.79 | 25.00 |
| 39.4304 | 39.53 | 2.28342 | 18.39 | 36.74 | 20.00 |
| 41.3044 | 27.33 | 2.18404 | 12.72 | 66.54 | 20.00 |
| 42.9449 | 35.56 | 2.10433 | 16.55 | 12.48 | 19.00 |
| 43.2432 | 30.16 | 2.09051 | 14.04 | 37.29 | 19.00 |
| 44.3539 | 10.55 | 2.04070 | 4.91 | 63.50 | 19.00 |
| 45.9020 | 12.60 | 1.97541 | 5.86 | 7.97 | 19.00 |
| 47.2551 | 66.10 | 1.92196 | 30.76 | 104.96 | 19.00 |
| 48.5662 | 22.75 | 1.87309 | 10.58 | 62.30 | 19.00 |
| 50.0442 | 12.78 | 1.82118 | 5.95 | 33.15 | 19.00 |
| 50.8492 | 30.12 | 1.79422 | 14.01 | 17.04 | 18.00 |
| 51.8936 | 46.61 | 1.76054 | 21.69 | 32.58 | 18.00 |
| 54.3785 | 31.46 | 1.68581 | 14.64 | 12.18 | 18.00 |
| 56.5315 | 20.60 | 1.62661 | 9.59 | 13.76 | 18.00 |
| 57.4773 | 13.54 | 1.60207 | 6.30 | 91.75 | 18.00 |
| 60.6488 | 15.23 | 1.52566 | 7.09 | 51.42 | 17.00 |
| 62.4657 | 38.95 | 1.48558 | 18.12 | 40.19 | 17.00 |
| 64.4080 | 10.86 | 1.44539 | 5.06 | 36.69 | 17.00 |
| 65.7220 | 7.83 | 1.41964 | 3.65 | 11.56 | 17.00 |
| 67.4035 | 6.11 | 1.38825 | 2.84 | 8.05 | 18.00 |
| 71.7524 | 4.55 | 1.31442 | 2.12 | 15.03 | 18.00 |
| 78.9154 | 4.79 | 1.21210 | 2.23 | 12.02 | 16.00 |
| 83.4887 | 5.09 | 1.15694 | 2.37 | 15.84 | 19.00 |
| 84.7678 | 10.56 | 1.14272 | 4.91 | 7.25 | 20.00 |
| 90.1227 | 13.02 | 1.08820 | 6.06 | 10.38 | 17.00 |
| 93.1439 | 8.37 | 1.06067 | 3.90 | 13.89 | 18.00 |
| 95.0796 | 7.47 | 1.04412 | 3.47 | 15.83 | 20.00 |
| 98.8925 | 8.06 | 1.01382 | 3.75 | 13.57 | 18.00 |
| 102.5534 | 6.87 | 0.98734 | 3.20 | 11.48 | 17.00 |

Total area = 3844.69

The XRD for7^{th} day-All Radiation:
Sample Identification:D: All Radiation
Comment: Exported by X'Pert SW
Start Position [°2 Th.]: 10.0100
End Position [°2 Th.]: 109.9900
Step Size [°2 Th.]: 0.0200
Scan Step Time [s]: 0.3500
Anode Material: Cu
Generator Setting: 40 Kv, 30 mA
Diffractometer Type:Xpert MPD

| | Height | d-spacing | | Area | Backgr. |
|---|---|---|---|---|---|
| Pos. [°2Th.] | [cts] | [?] | Rel. Int. [%] | [cps*°2Th.] | [cts] |
| 10.6712 | 5.06 | 8.28371 | 2.88 | 23.53 | 23.00 |
| 12.2160 | 17.69 | 7.23946 | 10.07 | 5.08 | 23.00 |
| 18.1224 | 36.83 | 4.89110 | 20.97 | 20.58 | 19.00 |
| 23.1526 | 16.50 | 3.83858 | 9.39 | 20.75 | 17.00 |
| 29.4903 | 175.64 | 3.02648 | 100.00 | 169.97 | 24.00 |
| 32.3494 | 69.84 | 2.76522 | 39.76 | 123.64 | 24.00 |
| 32.6621 | 74.52 | 2.73945 | 42.43 | 118.04 | 24.00 |
| 34.0867 | 68.24 | 2.62815 | 38.85 | 99.94 | 24.00 |
| 34.4543 | 56.38 | 2.60095 | 32.10 | 44.37 | 24.00 |
| 36.0430 | 23.50 | 2.48986 | 13.38 | 14.37 | 24.00 |
| 39.4420 | 38.40 | 2.28277 | 21.86 | 42.82 | 20.00 |
| 41.3426 | 36.91 | 2.18211 | 21.01 | 63.97 | 19.00 |
| 43.1360 | 40.46 | 2.09545 | 23.03 | 47.32 | 20.00 |
| 44.1788 | 14.13 | 2.04838 | 8.04 | 17.14 | 20.00 |
| 44.7123 | 12.32 | 2.02517 | 7.02 | 10.33 | 20.00 |
| 45.8165 | 12.93 | 1.97890 | 7.36 | 18.45 | 20.00 |
| 47.1397 | 31.76 | 1.92639 | 18.08 | 13.22 | 20.00 |
| 47.4571 | 46.54 | 1.91424 | 26.50 | 108.04 | 20.00 |
| 48.6159 | 31.20 | 1.87129 | 17.77 | 34.82 | 20.00 |
| 50.7950 | 17.69 | 1.79601 | 10.07 | 21.46 | 20.00 |
| 51.9093 | 45.53 | 1.76004 | 25.92 | 25.19 | 21.00 |
| 56.6255 | 21.08 | 1.62413 | 12.00 | 18.42 | 21.00 |
| 57.5270 | 10.85 | 1.60080 | 6.18 | 37.09 | 22.00 |
| 60.6582 | 11.89 | 1.52545 | 6.77 | 33.46 | 23.00 |
| 62.5199 | 35.62 | 1.48442 | 20.28 | 35.90 | 21.00 |
| 64.7035 | 7.73 | 1.43950 | 4.40 | 31.85 | 20.00 |
| 73.0669 | 5.82 | 1.29398 | 3.31 | 11.35 | 17.00 |
| 83.8222 | 6.18 | 1.15318 | 3.52 | 14.53 | 21.00 |
| 93.1235 | 5.34 | 1.06085 | 3.04 | 9.47 | 18.00 |
| 95.0025 | 11.89 | 1.04477 | 6.77 | 21.10 | 19.00 |
| 98.9154 | 6.66 | 1.01365 | 3.79 | 14.17 | 19.00 |
| 102.6349 | 7.61 | 0.98678 | 4.33 | 13.74 | 17.00 |
| 105.9622 | 2.49 | 0.96476 | 1.42 | 16.00 | 19.00 |

Total area = 3251.55

The XRD for 7^{th} day-Faradarmani:
Sample Identification: A: Faradarmani
Comment: Exported by X′Pert SW
Start Position [°2 Th.]: 10.0100
End Position [°2 Th.]: 109.9900
Step Size [°2 Th.]: 0.0200
Scan Step Time [s]: 0.3500
Anode Material: Cu
Generator Setting: 40 Kv, 30 mA
Scan Step Time [s]: 0.3500
Anode Material: Cu
Generator Setting: 40 Kv, 30 mA
Diffractometer Type:Xpert MPD

| | Height | d-spacing | | Area | Backgr. |
|---|---|---|---|---|---|
| Pos. [°2Th.] | [cts] | [?] | Rel. Int. [%] | [cps*°2Th.] | [cts] |
| 18.0888 | 45.07 | 4.90013 | 55.50 | 32.68 | 19.00 |
| 23.0834 | 10.06 | 3.84993 | 12.38 | 14.25 | 18.00 |
| 29.4926 | 77.67 | 3.02625 | 95.63 | 51.33 | 23.00 |
| 32.2726 | 58.94 | 2.77163 | 72.57 | 65.53 | 22.00 |
| 32.6892 | 81.21 | 2.73725 | 100.00 | 51.41 | 21.00 |
| 34.1826 | 79.61 | 2.62100 | 98.03 | 128.69 | 21.00 |
| 36.8797 | 8.67 | 2.43527 | 10.67 | 19.39 | 19.00 |
| 38.8675 | 13.54 | 2.31518 | 16.67 | 10.55 | 19.00 |
| 39.4711 | 20.70 | 2.28116 | 25.49 | 18.92 | 19.00 |
| 41.3079 | 37.96 | 2.18386 | 46.73 | 62.85 | 21.00 |
| 42.9856 | 22.48 | 2.10243 | 27.68 | 29.93 | 23.00 |
| 44.1714 | 9.16 | 2.04870 | 11.28 | 13.29 | 24.00 |
| 45.8772 | 10.65 | 1.97642 | 13.12 | 6.53 | 26.00 |
| 47.2136 | 51.14 | 1.92355 | 62.96 | 68.79 | 28.00 |
| 50.1453 | 13.71 | 1.81774 | 16.88 | 15.70 | 25.00 |
| 50.8380 | 30.47 | 1.79459 | 37.52 | 21.90 | 23.00 |
| 51.8736 | 30.35 | 1.76117 | 37.37 | 22.56 | 21.00 |
| 53.1445 | 6.71 | 1.72201 | 8.27 | 10.57 | 20.00 |
| 54.2852 | 7.27 | 1.68849 | 8.95 | 17.98 | 20.00 |
| 56.6290 | 21.28 | 1.62404 | 26.20 | 27.47 | 23.00 |
| 60.4530 | 7.18 | 1.53013 | 8.84 | 20.17 | 23.00 |
| 62.4588 | 39.24 | 1.48573 | 48.32 | 47.39 | 21.00 |
| 64.1898 | 12.95 | 1.44977 | 15.95 | 20.86 | 20.00 |
| 65.8562 | 7.44 | 1.41707 | 9.16 | 9.72 | 18.00 |
| 71.7133 | 7.97 | 1.31504 | 9.82 | 15.46 | 17.00 |
| 72.9008 | 6.81 | 1.29652 | 8.39 | 6.12 | 16.00 |
| 79.0091 | 3.84 | 1.21090 | 4.73 | 12.55 | 17.00 |
| 84.7397 | 8.43 | 1.14302 | 10.38 | 8.86 | 22.00 |
| 86.2859 | 8.03 | 1.12646 | 9.89 | 15.10 | 18.00 |
| 95.0726 | 11.07 | 1.04418 | 13.64 | 10.82 | 19.00 |
| 98.8767 | 3.44 | 1.01394 | 4.24 | 15.44 | 18.00 |
| 102.6360 | 7.41 | 0.98677 | 9.13 | 11.48 | 16.00 |
| 107.5626 | 5.02 | 0.95480 | 6.18 | 10.51 | 19.00 |

Total area = 2831.78

The XRD for 7^{th} day-Shared Mind
Sample Identification: A: Shared Mind
Comment: Exported by X'Pert SW
Start Position [°2 Th.]: 10.0100
End Position [°2 Th.]: 109.9900
Step Size [°2 Th.]: 0.0200
Scan Step Time [s]: 0.3500
Anode Material: Cu
Generator Setting: 40 Kv, 30 mA
Diffractometer Type:Xpert MPD

| | Height | d-spacing | | Area | Backgr. |
|---|---|---|---|---|---|
| Pos. [°2Th.] | [cts] | [?] | Rel. Int. [%] | [cps*°2Th.] | [cts] |
| 15.8751 | 7.88 | 5.57810 | 5.08 | 5.55 | 20.00 |
| 18.1018 | 133.11 | 4.89664 | 85.79 | 61.82 | 19.00 |
| 18.8815 | 5.46 | 4.69616 | 3.52 | 5.94 | 19.00 |
| 23.0827 | 21.03 | 3.85005 | 13.55 | 25.45 | 17.00 |
| 29.4967 | 155.15 | 3.02584 | 100.00 | 111.43 | 26.00 |
| 31.0565 | 10.62 | 2.87733 | 6.84 | 8.27 | 25.00 |
| 32.3086 | 80.69 | 2.76862 | 52.01 | 102.18 | 25.00 |
| 32.7108 | 55.59 | 2.73549 | 35.83 | 23.52 | 25.00 |
| 32.9311 | 10.71 | 2.71769 | 6.90 | 20.42 | 25.00 |
| 34.1500 | 113.59 | 2.62342 | 73.21 | 115.08 | 25.00 |
| 34.4782 | 63.10 | 2.59920 | 40.67 | 32.38 | 25.00 |
| 35.0664 | 9.67 | 2.55693 | 6.23 | 10.13 | 25.00 |
| 36.0171 | 16.51 | 2.49159 | 10.64 | 10.31 | 24.00 |
| 39.4865 | 35.91 | 2.28030 | 23.14 | 31.99 | 21.00 |
| 41.3638 | 37.50 | 2.18104 | 24.17 | 64.51 | 21.00 |
| 43.1320 | 36.27 | 2.09564 | 23.38 | 51.66 | 20.00 |
| 44.1118 | 14.94 | 2.05133 | 9.63 | 17.61 | 20.00 |
| 44.7394 | 12.68 | 2.02401 | 8.17 | 12.23 | 20.00 |
| 45.8174 | 12.21 | 1.97886 | 7.87 | 18.20 | 20.00 |
| 47.2527 | 66.98 | 1.92205 | 43.17 | 106.70 | 20.00 |
| 48.5317 | 19.53 | 1.87434 | 12.59 | 49.46 | 20.00 |
| 50.0721 | 14.64 | 1.82023 | 9.44 | 27.84 | 20.00 |
| 50.8689 | 49.24 | 1.79357 | 31.73 | 26.13 | 20.00 |
| 51.9190 | 45.41 | 1.75973 | 29.27 | 33.19 | 19.00 |
| 54.3592 | 16.13 | 1.68636 | 10.40 | 19.14 | 19.00 |
| 56.6567 | 25.05 | 1.62331 | 16.15 | 14.23 | 19.00 |
| 57.3957 | 11.71 | 1.60415 | 7.54 | 65.79 | 19.00 |
| 60.4770 | 15.06 | 1.52958 | 9.71 | 67.71 | 18.00 |
| 62.4566 | 37.77 | 1.48577 | 24.35 | 44.83 | 18.00 |
| 64.3384 | 11.36 | 1.44678 | 7.32 | 31.82 | 18.00 |
| 65.8065 | 7.09 | 1.41802 | 4.57 | 9.14 | 18.00 |
| 67.5382 | 12.94 | 1.38581 | 8.34 | 4.86 | 18.00 |
| 71.7965 | 7.84 | 1.31372 | 5.05 | 19.08 | 17.00 |
| 84.7748 | 16.76 | 1.14264 | 10.80 | 6.18 | 22.00 |
| 93.1707 | 5.35 | 1.06044 | 3.45 | 16.85 | 18.00 |
| 95.0712 | 10.04 | 1.04419 | 6.47 | 12.69 | 19.00 |
| 98.9317 | 8.09 | 1.01353 | 5.22 | 21.27 | 17.00 |

Total area = 3600.02

What is claimed is:

1. A method for improving product of an industrial process, comprising:
a) having a person who is connected to interuniversal consciousness that exists inherently in every person to exhibit a consciousness field;
b) having the person apply the consciousness field to an industrial process by associating the industrial process with the consciousness field to produce a product with a quality that is superior to a product obtained from the same industrial process without use of a consciousness field.

2. The method of claim 1, wherein the person obtains the consciousness field by connecting with another person who already is connected to the interuniversal consciousness.

3. The method of claim 2, wherein the connection can be in person.

4. The method of claim 2, wherein the connection can be over a communication network.

5. The method of claim 1, wherein the consciousness field that is applied is one or more of general consciousness field (Faradarmani), defensive radiation (Non organic Faradarmani), Purposeful Faradarmani (shared mind), and combination thereof (all radiation).

6. The method of claim 1, wherein the method results in a change of form and arrangement of molecules.

7. The method of claim 1, wherein the method results in formation or analysis of new compounds.

8. The method of claim 1, wherein the method results in a structure rehabilitation.

9. The method of claim 1, wherein applying the consciousness field involves being present at least once during the manufacturing process.

10. The method of claim 1, wherein the industrial process produces one or more of cement, nano materials, composites, alloys, catalysts, mixtures of chemicals, formulations of chemicals or ingredients, pharmaceuticals, disinfectants, or pain relievers.
